(19) United States
(12) Patent Application Publication
(10) Pub. No.: US 2018/0153279 A1
(43) Pub. Date: Jun. 7, 2018

(54) HEATING SUPPORT FOR A COSMETIC PRODUCT APPLICATOR WITH A HEATING ELEMENT

(71) Applicant: L'OREAL, Paris (FR)

(72) Inventors: Nicolas DURU, Saint Ouen (FR); Frédéric JOLLET, Saint Ouen (FR)

(21) Appl. No.: 15/568,588

(22) PCT Filed: Apr. 27, 2016
(86) PCT No.: PCT/EP2016/059433

§ 371 Date: Oct. 23, 2017

(30) Foreign Application Priority Data
Apr. 29, 2015 (FR) 15 53886

(51) Int. Cl. A45D 40/26; H05B 3/06

(52) U.S. Cl. CPC A45D 40/267; A45D 2200/157; H05B 3/06

(57) ABSTRACT

This invention relates to a cosmetic product applicator (10), including: a gripping member (18); a member (12) for applying a cosmetic product, with the application member comprising a longitudinal main body (62) and a plurality of protruding elements (63); and a heating element (20) comprising a resistive wire (54), with the application member and the heating element being integral with the gripping member.

The heating element comprises a tubular metal sheath (38), extending from an axial end (24) of the gripping member, with the resistive wire (54) being arranged inside said sheath and in thermal contact with an inner wall of said sheath. The main body (62) of the application member extends in parallel or coaxially to the tubular metal sheath (38) from the axial end (24) of the gripping member.

This invention relates to a heating support for a cosmetic product applicator, of the type comprising:
a gripping member,
a heating element comprising a resistive wire, said heating element extending along a first longitudinal axis from the gripping member.

By “cosmetic product”, we mean, in the sense of this invention, a product as defined in Regulation (EC) No 1223/2009 of the European Parliament and of the Council of Nov. 30, 2009, relating to the cosmetic products.

The cosmetic product intended to be applied by the applicator according to the invention is in particular in the form of a powder, a compacted solid, or a fluid such as a liquid. The product is advantageously a product intended to be placed on the keratin fibers of a user, such as the eyelashes or the eyelids. The product is for example a makeup product such as a mascara.

It is known to apply a makeup product such as a mascara using a heating element, intended to curve and/or extend the eyelashes. The document FR2996109 describes for example an applicator of the aforementioned type, wherein the resistive wire is disposed between the projecting elements of the brush, in such a way as to apply the mascara, comb and heat the eyelashes in a single gesture.

Such an applicator requires integrating the heating wire into the mascara brush, which is expensive and difficult to implement. This invention has for purpose to obtain at a lesser cost such an applicator of a cosmetic product, in particular mascara.

To this effect, the invention has for object a heating support of the aforementioned type, wherein the heating element further comprises a metal sheath, with the resistive wire arranged inside said sheath in thermal contact with an inner wall; and the heating element is able to be assemble to a member for the application of a cosmetic product onto keratin fibers.

According to further advantageous aspects of the invention, the heating support comprises one or several of the following features taken in isolation or in any technically possible combination:
the gripping member comprises a portion formed from a thermoplastic material molded onto an axial end of the tubular metal sheath,
the heating element further comprises a rod arranged inside the tubular metal sheath, with the resistive wire being wound around said rod,
the heating element further comprises a temperature sensor arranged inside the tubular metal sheath,
the heating element comprises an electrical energy source housed in the gripping member and connected to the resistive wire,
the gripping member extends according to a substantially longitudinal direction parallel to the first longitudinal axis of the heating element, preferably along a direction coaxial with the first axis.
the metal sheath is tubular,
the application member is able to be assembled to a member for applying a cosmetic product, directly or by the intermediary of the gripping member.

The invention also has for object an application member for an applicator of a cosmetic product on keratin fibers, in particular the eyelashes and the eyelids, with the application member comprising a main body with an elongated shape, arranged substantially along a second axis, and a plurality of application elements extending laterally protruding from said main body, characterized in that the main body forms a sleeve able to receive a sheath of a heating element of a heating support such as defined hereinabove, with the main body further comprising a lateral opening.

Advantageously, the sleeve is tubular with an internal cavity of elongated shape, with at least one axial end of the internal cavity being open, with the lateral opening giving access to the inside of the main body.

The invention also relates to an applicator of a cosmetic product on the keratin fibers including:
a heating support; and
a member for applying a cosmetic product on the keratin fibers, with the application member comprising a main body with an elongated shape, substantially arranged along a second axis, and a plurality of application elements extending laterally protruding from said main body,
with the application member being assembled to the metal sheath of the heating element. Advantageously, the application member is assembled to the metal sheath of
   the heating element by the intermediary of the gripping member assembles on the application member.

Advantageously, the application member is such as defined hereinabove. Preferably, the sheath of the heating element is inserted into the internal cavity of the main body of the application member, with a portion of the sheath accessible via the lateral opening.

The invention further relates to a method for producing a heating support such as described hereinabove, including the following steps:
inserting into a metal sheath of a resistive wire, preferably wound on a rod;
over-molding of a thermoplastic material on an end of the metal sheath in order to form a portion of a gripping member.

The method can have the following characteristic:
a prior step of coating with a heat conducting glue on the resistive wire.

The invention further relates to a method for manufacturing an applicator such as described hereinabove comprising a step of assembling the end of the gripping member with an member for applying a cosmetic product on keratin fibers.

The invention will be easier to understand in view of the following description, provided solely as a non-restricted example and with reference to the drawings, wherein:

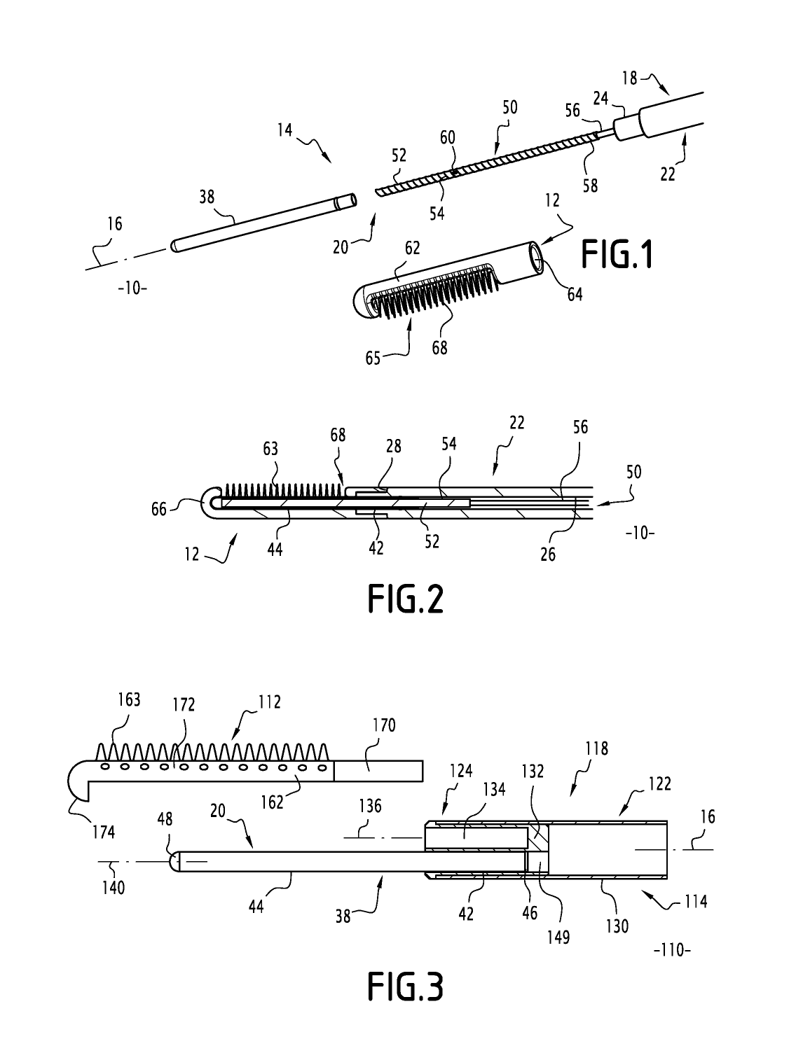

FIG. 1 is a partial exploded perspective view of an applicator according to a first embodiment of the invention and of a heating support for such an applicator;

FIG. 2 is a partial longitudinal cross-section view of the applicator of FIG. 1; and

FIG. 3 is a partial lateral view of an applicator according to a second embodiment of the invention, with a heating support seen as a longitudinal cross section.

FIGS. 1 and 2 show a partial view of an applicator 10 according to a first embodiment of the invention. FIG. 3 shows a partial view of an applicator 110 according to a second embodiment of the invention. The applicator 10, 110 is intended to apply a cosmetic product, in particular a mascara, on the keratin fibers of a user, in particular the eyelashes or the eyelids.

In the following description, the elements common to the applicators 10 and 110 are designated by the same reference numbers.

The applicator 10, 110 comprises an application member, here a brush 12, 112 for mascara. The applicator 10, 110 also comprises a gripping device 14, 114 assembled or intended to be assembled to the brush 12, 112.

The gripping device 14, 114 has an elongated shape, extending substantially along a first axis 16. The gripping device 14, 114 in particular comprises a gripping member that has the form of a sleeve 18, 118, arranged according to the axis 16. The gripping device 14, 114 also comprises a heating element 20, able to heat the keratin fibers of the user, in particular the eyelashes or the eyebrows.

The sleeve 18, 118 comprises a proximal portion (not shown) and a distal portion 22, 122, adjacent along the axis 16. Opposite the proximal portion, the distal portion 22, 122 comprises a distal end 24, 124. Said distal end 24, 124 comprises means of assembly with an application member, here the brush 12, 112.

In the embodiment of FIGS. 1 and 2, the distal portion 22 of the sleeve 18 if formed from a part, in particular by a thermoplastic material. The distal portion 22 has a shape of revolution about the axis 16. An inner wall of the distal portion 22 has a cylindrical shape, defining a tubular cavity 26 that passes through said distal portion 22 along the axis 16.

An outer wall of the distal portion 22 comprises a shoulder 28 axially delimiting the distal end 24. Said distal end 24 has an outer diameter less than the outer diameter of the rest of the distal portion 22. As described hereinbelow, the brush 12 can be press fitted onto the distal end 24, abutting axially against the shoulder 28.

In the embodiment of la FIG. 3, the distal portion 122 comprises a tube 130 arranged along the axis 16. An end of said tube 130 is press fitted onto an insert 132 that forms the distal end 124 of the distal portion 122. The insert 132 is formed from a thermoplastic material. The insert 132 comprises a blind hole 134, arranged according to a second axis 136, parallel to the first axis 16 and not confounded with said first axis 16. The blind hole 134 is oriented towards the outside of the tube 130 and allows for the assembly of the gripping device 114 with the brush 112 in order to form the applicator 110.

The heating element 20 comprises a tubular metal sheath 38, of substantially cylindrical shape, preferentially cylindrical of revolution. La tubular metal sheath 38 is for example made from stainless steel, in particular from stainless steel 316. As an example, the sheath 38 has an outer diameter of about 2 mm and an axial length of about 40 mm.

In the embodiment of FIGS. 1 and 2, the sheath 38 extends along the first axis 16. In the embodiment of FIG. 3, the sheath 38 extends along a third axis 140, parallel to the first 16 and to the second 136 axes and not confounded with said first and second axes.

The tubular metal sheath 38 comprises a proximal portion 42 and a distal portion 44, adjacent along the axis 16 or 140. The proximal portion 42 is arranged inside the sleeve 18, 118 and the distal portion 44 forms an axial protrusion with respect to the distal end 24, 124 of said sleeve.

A proximal end 46 of the tubular sheath 38 is open. A distal end 48 of said sheath 38 is preferentially closed. The sheath 38 is in particular manufactured via a method of deep drawing or made from an open tube provided with a shutter at its distal end 48. Alternatively, the distal end can be open.

In the embodiment of FIGS. 1 and 2, the proximal portion 42 of the sheath 38 is inserted into the distal portion 22 of the sleeve 18. The tubular cavity 26 of said distal portion 22 extends the tube formed by the sheath 38, along the axis 16.

In the embodiment of FIG. 3, the proximal portion 42 of the sheath 38 is embedded into the insert 132. An axial opening 149 of said insert is adjacent to the proximal end 46 of the sheath 38. The opening 149 places into communication the inside of the sheath 38 with the inside of the tube 130 of the sleeve 118.

The heating element 20 further comprises a resistive element 50, which can be seen in FIGS. 1 and 2. The resistive unit 50 is not shown in FIG. 3.

The resistive unit 50 comprises a rod 52, able to be inserted into the tubular metal sheath 38. Preferably, the rod 52 is made from an electrically insulated material such as a plastic. Alternatively the resistive unit may not comprise the support 52.

The resistive unit 50 further comprises a resistive wire 54 wound around the rod 52. The resistive wire 54 is for example made of Nichrome with a diameter of 0.14 mm.

Preferably, the resistive wire 54 is wound around an entire length of the rod 52. Preferably, the resistive wire 54 is wound in the form of a double helix around the rod 52, in such a way that two ends 56 of said wire extend in the sleeve 18, 118 from a proximal end 58 of the rod 52.

The rod 52 is inserted into the tubular metal sheath 38 in such a way that the resistive wire 54 is in thermal contact with an inner wall of said sheath. Preferably, the wire 54 is glued to said inner wall of the sheath 38, using a glue that allows for good thermal conduction between said wire and said sheath.

The resistive unit 50 further comprises a temperature sensor 60, arranged on the rod 52 and a thermal contact with the inner wall of the sheath. The sensor 60 is for example an NTC thermistor.

The heating element 20 further comprises a source of electrical power (not shown), housed in the proximal portion of the sleeve 18, 118. The ends 56 of the resistive wire 54 extend in the tubular cavity 26 or in the tube 130 of the sleeve 18, 118 and are connected to said source of electrical power, which as such supplies the wire 54. Preferably, the source of power is connected to a switch arranged on the surface of the proximal portion of the sleeve 18, 118.

Preferably, the heating element 20 further comprises an electronic regulation device (not shown), housed in the proximal portion of the sleeve 18, 118. Such an electronic device comprises for example an electronic board to which is connected the temperature sensor 60. Such an electronic device makes it possible in particular to limit to a determined range the temperature measured by the sensor 60. Such a range is for example defined between 50° C. and 70° C. The risks of burns of a user are as such limited.

The brush 12, 112 of the applicator 10, 110 comprises a main body 62, 162, of substantially straight shape. The brush 12, 112 further comprises a plurality of protruding elements 63, 163 forming application elements that extend radially outwards from the main body 62, 162.

In the embodiment of FIGS. 1 and 2, the main body 62 of the brush 12 assembled to the gripping device 14 extends according to the first axis 16. In the embodiment of FIG. 3, the main body 162 of the brush 112 assembled to the gripping device 114 extends according to the second axis 136.

In the embodiment of FIGS. 1 and 2, the main body 62 forms a sleeve. More precisely, the main body 62 has a tubular shape with an internal cavity 65 of elongated shape. The internal cavity 65 has an open proximal end 64 and a closed distal end 66. A wall of the internal cavity 65 has a shape that is substantially complimentary with the distal portion 44 of the sheath 38. In the vicinity of the proximal end 64, said wall of the internal cavity 65 has a complementary shape with the distal end 24 of the sleeve 18.

The main body 62 comprises a lateral opening 68 that gives access to the inside of said body. The lateral opening 68 has an elongated shape and extends preferably over at least 50%, more preferentially over at least 75%, of a length of the brush 12 along the axis 16. In width, the lateral opening 68 extends preferably over an angular portion between 10° and 350° about the axis 16. The protruding elements 63 are arranged around the lateral opening 68, preferably close to a periphery of said opening. In other terms, the lateral opening is located substantially at the foot of the application elements.

In the embodiment of FIG. 3, the main body 162 has a solid shape. A proximal portion 170 of said main body has a shape substantially complementary of the blind hole 134 of the sleeve 118.

A distal portion 172 of said main body has a length close to that of the distal portion 44 of the sheath 38. The protruding elements 163 are arranged on said distal portion 172. Preferably, the distal portion 172 of the main body 162 comprises a means 174 of assembly with the distal portion 44, in particular with the distal end 48, of the sheath 38. The means of assembly 174 has for example the shape of a cap that nests onto the distal end 48 of the sheath 38.

Advantageously, the application member formed by the brush 12, 112 is made of elastomer material.

A method for manufacturing the gripping device 14, 114 and of the applicator 10, 110 will now be described.

First of all, the distal end 24, 124 of the sleeve 18, 118 is molded on the metal sheath 38 of the heating element 20. In the embodiment of FIGS. 1 and 2, the distal portion 22 of the sleeve 18 is molded on the proximal portion 42 of the sheath 38, by arranging the tubular cavity 26 that extends in the direction of the proximal portion of said sleeve 18. In the embodiment of FIG. 3, the insert 132 is molded on the proximal portion 42 of the sheath 38, by arranging the blind hole 134 and the axial opening 149.

Such a step of molding makes it possible to provide an excellent seal between the sheath 38 and the distal end 24, 124 of the sleeve 18, 118. In particular, the molding makes it possible to prevent the cosmetic composition from penetrating inside the sleeve 18, 118 during the use, which could damage the electrical connections of the wire 54, or generate a bacteriological contamination of the sleeve.

In a second step of the method, the resistive unit 50 described hereinabove is inserted into the sheath 38, by the tubular cavity 26 of the sleeve 18 or the axial opening 149 of the insert 132, and by the proximal end 46 of said sheath 38. Preferably, the rod 52 and the wire 54 wound on said rod are coated with glue before being inserted into the sheath 38. In the embodiment of FIG. 3, the tube 130 of the distal portion 122 of the sleeve 118 is then press fitted onto the insert 132 and fixed to said insert.

The ends 56 of the resistive wire 54 are arranged in the tubular cavity 26 of the distal portion 22 of the sleeve 18, or in the tube 130 of the distal portion 122 of the sleeve 118.

According to an embodiment, the distal portion 22, 122 of the sleeve 18, 118 is then connected to a proximal portion in order to form said sleeve 18, 118. Such a proximal portion of the sleeve comprises a source of electrical power and, possibly, an electronic regulation device. The ends 56 of the resistive wire 54 are connected to the source of electrical power and the sensor 60 is possibly connected to the electronic regulation device.

According to another embodiment, the proximal portion of the sleeve 18, 118 is formed from a part with the distal portion 22 or with the tube 130. The source of electrical power and, possibly, the electronic regulation device, are added in said proximal portion after the insertion of the resistive unit 50 into the sheath 38.

The gripping device 14, 114 is as such obtained.

In order to obtain the applicator 10, 110 from the gripping device 14, 114, the brush 12, 112 is then assembled to said gripping device. In the embodiment of FIGS. 1 and 2, the main body 62 of the brush 12 is threaded onto the distal portion 44 of the sheath 38 and onto the distal end 24 of the sleeve 18, until abutment of the proximal end 64 of said main body 62 against the shoulder 28 of said sleeve 18. The distal portion 44 of the sheath 38 is as such covered, except for a zone that can be accessed through the lateral opening 68 of the brush 12.

In the embodiment of FIG. 3, the proximal portion 170 of the main body 162 is inserted into the blind hole 134 of the insert 132. Preferably, the distal portion 172 of said main body is assembled to the distal portion 44 of the sheath 38. The main body 162 is as such arranged parallel to the distal portion 44 of the sheath 38, integral with said distal portion 44. Said distal portion 44 can be accessed laterally, on a side opposite the brush 12.

The brush 12, 112 is for example fixed to the gripping device 14, 114 by gluing, welding or crimping. The applicator 10, 110 is as such obtained.

According to this method of manufacturing the applicator 10, 110, the brush 12, 112 is assembled to the gripping device 14, 114 in the last step of the method. It is as such possible to manufacture in large quantities the gripping device 14, 114, i.e. the applicator 10, 110 devoid of the brush 112. To each gripping device 14, 114 is then added a brush 12, 112, chosen from among several different models according to the application desired. Gripping devices 14, 114 from the same batch can therefore be assembled to several types of brushes 12, 112 for different uses.

Preferably, the applicator 10, 110 is part of a makeup unit, further comprising a receptacle filled with a cosmetic composition such as a mascara. In a known manner, the receptacle preferentially comprises an opening provided with means of assembly with the applicator 10, 110, in such a way that the brush 12, 112 is received inside said receptacle in an assembled position. In a known manner, the opening of the receptacle is preferentially provided with a squeezing device so as to remove from the brush 12, 112 an excess of cosmetic composition when the applicator 10, 110 is dissociated from said receptacle.

A method of using the applicator 10, 110 in such a makeup unit comprises for example the following steps: a user grasps the applicator 10, 110 by the sleeve 18, 118. The user soaks the brush 12, 112 in the cosmetic composition contained in the receptacle, then passes on the eyelashes the protruding elements 63, 163 of said brush. The eyelashes are as such brushed and coated with the cosmetic composition.

Then, the user actuates the switch (not shown) located on the proximal portion of the sleeve 18, 118. The wire 54 is supplied with power and diffuses heat to the metal sheath 38. The sheath 38 doubles as a heat dissipater, which guarantees a homogeneous temperature along said sheath. Preferably, the electronic regulation device, using the heat sensor 60, limits the temperature of the sheath to a determined range.

The user passes over the eyelashes the heated sheath 38. The action of the heat curves the eyelashes and dries the mascara. In the embodiment of FIGS. 1 and 2, the arrangement of the protruding elements 63 around the lateral opening 68 of the brush 12 makes it possible to heat and to brush the eyelashes in the same gesture. In the embodiment of FIG. 3, the user rotates between her fingers the sleeve 118 in order to place in alternation her eyelashes into contact with the protruding elements 163 of the brush 112 and with the distal portion 44 of the heated sheath 38.

1. A heating support for a cosmetic product applicator, comprising:
a gripping member,
a heating element comprising a resistive wire, said heating element extending along a first longitudinal axis from the gripping member,
wherein:
the heating element further comprises a metal sheath, with the resistive wire being arranged inside said sheath in thermal contact with an inner wall; and in that
the heating element is able to be assembled to a member for applying a cosmetic product on keratin fibers.

2. The heating support according to claim 1, wherein the gripping member comprises a portion formed from a thermoplastic material molded onto an axial end of the tubular metal sheath.

3. The heating support according to claim 1, wherein the heating element further comprises a rod arranged inside the tubular metal sheath, with the resistive wire being wound around said rod.

4. The heating support according to claim 1, wherein the heating element further comprises a temperature sensor arranged inside the tubular metal sheath.

5. The heating support according to claim 1, wherein the heating element comprises an electrical energy source housed in the gripping element and connected to the resistive wire.

6. The heating support according to claim 1, wherein the gripping member extends according to a substantially longitudinal direction parallel to the first longitudinal axis of the heating element.

7. An application member for a cosmetic product on keratin fibers with the application member comprising:
a main body of elongated shape, substantially arranged along a second axis, and
a plurality of application elements extending laterally protruding from said main body,
wherein the main body forms a sleeve able to receive a sheath of a heating element of a heating support according to claim 1, with the main body further comprising a lateral opening.

8. A cosmetic product applicator comprising:
a heating support according to claim 1; and
a member for applying a cosmetic product on the keratin fibers, with the application member comprising a main body with an elongated shape, substantially arranged along a second axis, and a plurality of application elements extending laterally protruding from said main body,
with the application member being assembled to the metal sheath of the heating element.

9. The applicator according to claim 8, wherein the application member comprises:
a main body of elongated shape, substantially arranged along a second axis, and
a plurality of application elements extending laterally protruding from said main body,
wherein the main body forms a sleeve able to receive a sheath of a heating element of a heating support comprising:
a gripping member,
a heating element comprising a resistive wire, said heating element extending along a first longitudinal axis from the gripping member, wherein: the heating element further comprises a metal sheath, with the resistive wire being arranged inside said sheath in thermal contact with an inner wall; and in that the heating element is able to be assembled to a member for applying a cosmetic product on keratin, with the main body further comprising a lateral opening.

10. A method for producing a heating support according to claim 1, comprising the following steps:
inserting into a metal sheath of a resistive wire;
over-molding of a thermoplastic material on an end of the metal sheath in order to form a portion of a gripping member.

11. The method according to claim 10, comprising a prior step of coating with a heat conducting glue on the resistive wire.

12. A method for manufacturing an applicator according to claim 8 from a heating support comprising:
a gripping member,
a heating element comprising a resistive wire, said heating element extending along a first longitudinal axis from the gripping member, wherein: the heating element further comprises a metal sheath, with the resistive wire being arranged inside said sheath in thermal contact with an inner wall; and in that the heating element is able to be assembled to a member for applying a cosmetic product on keratin, comprising a step of assembling of the end of the gripping member with a member for applying a cosmetic product on the keratin fibers.

13. The heating support according to claim 2, wherein the heating element further comprises a rod arranged inside the tubular metal sheath, with the resistive wire being wound around said rod.

14. The heating support according to claim 2, wherein the heating element further comprises a temperature sensor arranged inside the tubular metal sheath.

15. The heating support according to claim 3, wherein the heating element further comprises a temperature sensor arranged inside the tubular metal sheath.

16. The heating support according to claim 2, wherein the heating element comprises an electrical energy source housed in the gripping element and connected to the resistive wire.

17. The heating support according to claim 3, wherein the heating element comprises an electrical energy source housed in the gripping element and connected to the resistive wire.

18. The heating support according to claim 4, wherein the heating element comprises an electrical energy source housed in the gripping element and connected to the resistive wire.

19. The heating support according to claim 2, wherein the gripping member extends according to a substantially longitudinal direction parallel to the first longitudinal axis of the heating element.

20. The heating support according to claim 3, wherein the gripping member extends according to a substantially longitudinal direction parallel to the first longitudinal axis of the heating element.
